(19) United States
(12) Patent Application Publication
(10) Pub. No.: US 2014/0207639 A1
(43) Pub. Date: Jul. 24, 2014

(54) Variable-Based Increment Adjustment

(71) Applicant: TRADING TECHNOLOGIES INTERNATIONAL, INC., Chicago, IL (US)

(72) Inventor: Michael Unetich, Chicago, IL (US)

(73) Assignee: TRADING TECHNOLOGIES INTERNATIONAL, INC., Chicago, IL (US)

(21) Appl. No.: 13/746,877

(22) Filed: Jan. 22, 2013

(51) Int. Cl. G06Q 40/04

(52) U.S. Cl. CPC G06Q 40/04
USPC 705/37

(57) ABSTRACT

Example methods, systems, and computer-readable media are disclosed to provide variable-based increment adjustment. An example method includes determining, using a computing device, whether to automatically adjust a first trading increment implemented in a trading interface to a second trading increment by monitoring for a condition related to activity in a trading market. The condition is defined in an increment adjustment rule by a user. The first trading increment and the second trading increment are associated with prices in the trading market. The example method includes adjusting, using the computing device, the first trading increment to the second trading increment implemented in the trading interface during the condition according to the increment adjustment rule.

### CROSS-REFERENCE TO RELATED APPLICATIONS

This patent document relates to U.S. Pat. No. 7,577,602, entitled “Method and Interface for Consolidating Price Levels on a Trading Screen,” filed on Nov. 26, 2002, and issued on Aug. 18, 2009; U.S. Pat. No. 7,577,607, entitled “Method and Interface for Consolidating Price Levels on a Trading Screen,” filed on May 2, 2006, and issued on Aug. 18, 2009; U.S. Pat. No. 7,844,532, entitled “Method and Interface for Consolidating Price Levels on a Trading Screen,” filed on Jul. 14, 2009, and issued on Nov. 30, 2010; U.S. Pat. No. 8,195,554, entitled “Method an Interface for Consolidating Price Levels on a Trading Screen,” filed on Oct. 19, 2010, and issued on Jun. 5, 2012; and U.S. patent application Ser. No. 13/454,586, entitled “Method and Interface for Consolidating Price Levels on a Trading Screen,” and filed on Apr. 24, 2012. The contents of these related patent documents are herein incorporated by reference in their entireties.

### BACKGROUND

An electronic trading system generally includes a trading device in communication with an electronic exchange. The electronic exchange sends information about a market, such as prices and quantities, to the trading device. The trading device sends messages, such as messages related to orders, to the electronic exchange. The electronic exchange attempts to match quantity of an order with quantity of one or more contra-side orders.

A market may include outstanding bid and ask quantities at a variety of different price levels. The market implements a tick size or increment to define a smallest tradable price level graduation in the market. For example, a tick may represent a fraction of a dollar (e.g., one cent) or another currency, or a tick may represent a decimal portion of a dollar or another currency.

### BRIEF DESCRIPTION OF THE FIGURES

Certain embodiments are disclosed with reference to the following drawings.

FIG. 1 illustrates a block diagram representative of an example electronic trading system in which certain embodiments may be employed.

FIG. 2 illustrates a block diagram of another example electronic trading system in which certain embodiments may be employed.

FIG. 3 illustrates a block diagram of an example computing device which may be used to implement the disclosed embodiments.

FIG. 4 illustrates a flow diagram of an example method for facilitating increment adjustment on a trading interface.

FIG. 5 illustrates a flow diagram of an example method for facilitating variable-based increment adjustment on a trading interface.

FIG. 6 illustrates an example trading interface implemented using the methods of FIGS. 4 and/or 5.

FIG. 7 illustrates a flow diagram of an example method for facilitating variable-based increment adjustment in a trading strategy.

FIG. 8 illustrates a flow diagram of an example method for facilitating variable-based increment adjustment in a market.

FIG. 9 illustrates a block diagram of an example increment adjustment system to implement the methods of FIGS. 4, 5, 6, and/or 7.

Certain embodiments will be better understood when read in conjunction with the provided figures, which illustrate examples. It should be understood, however, that the embodiments are not limited to the arrangements and instrumentality shown in the attached figures.

### DETAILED DESCRIPTION

Many different exchanges support electronic trading. Electronic trading allows a trader or trading application to interact with the exchanges from a remote location. Once connected to an exchange, the trader or trading application may receive market information about tradable objects that are traded on the exchange. Market information may include bid prices, bid quantities, ask prices, ask quantities, prices and quantities for past sales, and/or other market related information. The trader or trading application may additionally trade the tradable objects, such as by entering buy or sell orders.

Prices (e.g., bid prices and/or ask prices) may be set at a variety of different price levels. Particular markets and/or exchanges may implement a tick size or increment to define a smallest tradable price level graduation in a market. For example, a tick or increment may represent a fraction of a dollar (e.g., one cent) or another currency, or a tick or increment may represent a decimal portion of a dollar or another currency. Exchanges may make traders and/or trading applications aware of the particular increment implemented in a particular market and/or exchange by broadcasting increment information to the traders and/or trading applications. Traders and/or trading applications may use this increment information when, for example, designing trading strategies and/or trading algorithms.

Some markets accept bids at different price increments. For example, some equity markets may accept bids at price increments of 0.01, but may also accept bids at price increments of 0.001. Where a market accepts different price increments, a best bid may be at a particular increment (e.g., pennies) and this best bid may be beat by a bid adding a fraction of the particular increment (e.g., fractions of pennies). For example, a best bid may be $46.01. A bid may then be made at $46.011 to beat this best bid. Such a situation may be referred to as “cutting in line” or gaining priority. Some regulations attempt to prevent such “cutting in line” by defining minimum trading increments so that a bid may not be beat by a small fraction of an increment.

Some markets accept bids at defined price increments (e.g., they accept bids only at a particular price increment). For example, some futures markets (e.g., crude oil) set an acceptable price increment to 0.01 (e.g., a penny). Prices may vary from, for example, $85.46 to $85.47.

Market conditions (e.g., market volatility) and/or trading conditions may affect spreads (e.g., bid/ask spreads) in a market. Market volatility is a measure for variation of price of a trading instrument over time. In some examples, when a market is non-volatile, a spread width may be more narrow (e.g., 0.01). When the market is volatile, the spread may widen (e.g., may widen from 0.01 to 0.05).

A trader and/or trading application may implement a trading strategy to define a profit objective using a particular trading increment (e.g., 0.01) based on the spread width when a market is non-volatile. A trading strategy may specify that an ask price is to be one increment (e.g., 0.01) above the buy price. For example, in a crude oil market, if a buy order is entered at $85.44, a trading strategy may set an ask price to $85.45 (e.g., $85.44+$00.01). However, when the market becomes volatile, the reward of such a trading strategy trading in 0.01 increments is often not worth the risk. For example, as market prices are moving quickly, it is undesirable to risk fifty pennies to make a profit of one penny.

A trading interface may be used by a trader to execute trades. A trading interface may provide a market depth ladder or market grid showing quantities available at an inside market and at other prices away from the inside market. The market depth ladder may illustrate prices and quantities at a particular increment (e.g., 0.01). However, it may be desirable to view the market depth ladder at a different increment (e.g., 0.05). For example, where a market becomes volatile and prices move quickly, the market depth ladder at the particular increment may not show a sufficient number of prices or a sufficient number of contracts available to trade may not be displayed.

Some trading interfaces provide a slide bar to allow a trader to alter the increments displayed in the trading interfaces. When altering the increments in the trading interface, prices are consolidated so that prices are shown in the desired range. For example, prices may be at 0.001 increments, but may be consolidated such that the prices are displayed at 0.01 increments. Consolidating prices in accordance with a particular increment does not affect how increments are implemented by a market and/or exchange, but rather facilities ease of use of the trading interface by a trader.

While slide bars allow a trader to alter increments displayed in a trading interface, a trader may have numerous trading interface windows (e.g., 50-200) open at a time. Adjusting a slide bar in each of these windows may be cumbersome and time intensive. For example, when a market becomes volatile, it may take too long for a trader to adjust a slide bar in each open window.

It is desirable to provide automatic adjustment of increment settings based on different variables in trading interfaces, trading strategies, and/or markets. Examples disclosed herein enable variable-based increment adjustment. In examples disclosed herein, increment adjustment rules are defined to specify particular market conditions and/or trading conditions and how trading increments are to be implemented during such market conditions and/or trading conditions. Increment adjustment rules may be specified by a definition which includes logic expressions and/or parameters that describe particular market conditions and/or trading conditions. Market conditions may relate to market volatility, volume (e.g., trade size) in the market. Trading conditions may relate to individual position size, position size of a firm, previously entered order sizes, etc.

Some examples disclosed herein alter increments in a trading interface. Increment adjustment rules are defined to specify how increments are to be displayed in the trading interface based on market conditions and/or trading conditions. When particular market conditions and/or trading conditions occur, particular increments are displayed in the trading interface. When the market conditions and/or trading conditions change, the increments of the trading interface are adjusted in accordance with the increment adjustment rules. For example, an increment adjustment rule may specify that when a market is non-volatile, increments are set to 0.01 and when the market is volatile, increments are set to 0.05. In a trading interface displaying a market depth ladder, when the market is non-volatile, the increments at the market depth ladder are 0.01. When the market becomes volatile, the increments at the market depth ladder are automatically adjusted to 0.05.

Some examples disclosed herein alter increments in a trading strategy. Increment adjustment rules are defined to specify how increments are to affect trading strategies (e.g., a trading algorithm) based on market conditions and/or trading conditions. When particular market conditions and/or trading conditions occur, particular increments are implemented in the trading algorithm. When the market conditions and/or trading conditions change, the increments implemented in the trading algorithm are adjusted in accordance with the increment adjustment rules. For example, an increment adjustment rule may specify that when a market is non-volatile, increments are set to 1x, where x is an increment set by an exchange, and that when the market is volatile, increments are set to 5x. For a trading algorithm being executed at a trading device, when the market is non-volatile, the increments in the trading algorithm are 1x. When the market becomes volatile, the increments in the trading algorithm are 5x.

Some examples disclosed herein alter increments in a market. Increment adjustment rules are defined to specify how increments are to be implemented in a market based on market conditions. When particular market conditions occur, particular increments are implemented by an exchange in the market. When the market conditions change, the increments implemented by the exchange in the market are adjusted in accordance with the increment adjustment rules. For example, an increment adjustment rule may specify that when a market is non-volatile, increments are set to 0.001, and that when the market is volatile, increments are set to 0.01. When the market is non-volatile, the increment for the market is broadcast as 0.001. Alternatively, when the market is non-volatile, the exchange accepts orders on increments of 0.001. When the market is volatile, the increment for the market is broadcast as 0.01. Alternatively, when the market is volatile, the exchange accepts orders on increments of 0.01. For example, the exchange recognizes an order at a price of $4.01, not at a price of $4.011. If orders are submitted at a price not recognized by the exchange during the particular market conditions, the exchange may round the price to the nearest increment as defined by the increment adjustment rule.

Although this description discloses embodiments including, among other components, software executed on hardware, it should be noted that the embodiments are merely illustrative and should not be considered as limiting. For example, it is contemplated that any or all of these hardware and software components may be embodied exclusively in hardware, exclusively in software, exclusively in firmware, or in any combination of hardware, software, and/or firmware. Accordingly, certain embodiments may be implemented in other ways.

### I. BRIEF DESCRIPTION OF CERTAIN EMBODIMENTS

Example methods, systems, and computer-readable media are disclosed to provide variable-based increment adjustment. An example method includes determining, using a computing device, whether to automatically adjust a first trading increment implemented in a trading interface to a second trading increment by monitoring for a condition related to activity in a trading market. The condition is defined in an increment adjustment rule by a user. The first trading increment and the second trading increment are associated with prices in the trading market. The example method includes adjusting, using the computing device, the first trading increment to the second trading increment implemented in the trading interface during the condition according to the increment adjustment rule.

An example system includes an adjustment comparator to determine whether to automatically adjust a first trading increment implemented in a trading interface to a second trading increment by monitoring for a condition related to activity in a trading market. The condition is defined in an increment adjustment rule by a user. The first trading increment and the second trading increment are associated with the trading market. The example system includes an increment adjustor module to adjust the first trading increment to the second trading increment implemented in the trading interface during the condition according to the increment adjustment rule.

An example tangible computer-readable storage medium comprises instructions that, when executed, cause a computing device to determine whether to automatically adjust a first trading increment implemented in a trading interface to a second trading increment by monitoring for a condition related to activity in a trading market. The condition is user-defined in one or more increment adjustment rules. The first trading increment and the second trading increment are associated with the trading market. The example instructions cause the computing device to adjust the first trading increment to the second trading increment implemented in the trading interface during the condition according to the increment adjustment rule.

### II. EXAMPLE ELECTRONIC TRADING SYSTEM

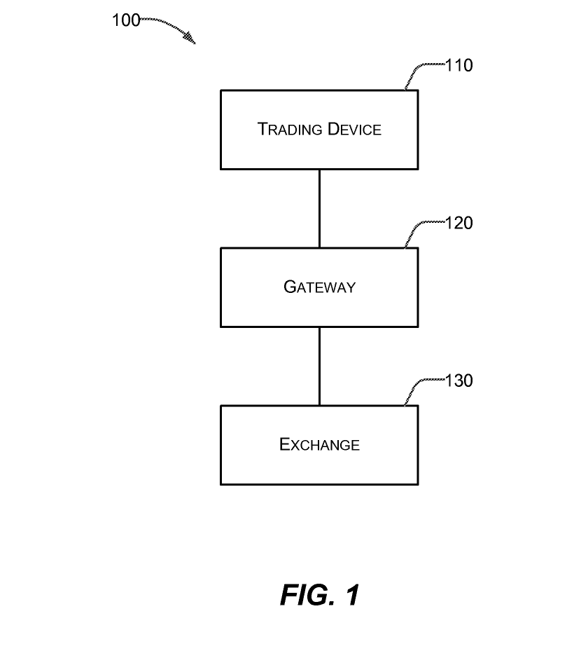

FIG. 1 illustrates a block diagram representative of an example electronic trading system 100 in which certain embodiments may be employed. The system 100 includes a trading device 110, a gateway 120, and an exchange 130. The trading device 110 is in communication with the gateway 120. The gateway 120 is in communication with the exchange 130. As used herein, the phrase “in communication” encompasses direct communication and/or indirect communication through one or more intermediary components. The exemplary electronic trading system 100 depicted in FIG. 1 may be in communication with additional components, subsystems, and elements to provide additional functionality and capabilities without departing from the teaching and disclosure provided herein.

In operation, the trading device 110 may receive market data from the exchange 130 through the gateway 120. A user may utilize the trading device 110 to monitor this market data and/or base a decision to send an order message to buy or sell one or more tradable objects to the exchange 130.

Market data may include data about a market for a tradable object. For example, market data may include the inside market, market depth, last traded price (“LTP”), a last traded quantity (“LTQ”), or a combination thereof. The inside market is the lowest available ask price (best offer) and the highest available bid price (best bid) in the market for a particular tradable object at a particular point in time (since the inside market may vary over time). Market depth refers to quantities available at the inside market and at other prices away from the inside market. Due to the quantity available, there may be “gaps” in market depth.

A tradable object is anything which may be traded. For example, a certain quantity of the tradable object may be bought or sold for a particular price. A tradable object may include, for example, financial products, stocks, options, bonds, future contracts, currency, warrants, funds derivatives, securities, commodities, swaps, interest rate products, index-based products, traded events, goods, or a combination thereof. A tradable object may include a product listed and/or administered by an exchange (for example, the exchange 130), a product defined by the user, a combination of real or synthetic products, or a combination thereof. There may be a synthetic tradable object that corresponds and/or is similar to a real tradable object.

An order message is a message that includes a trade order. A trade order may be, for example, a command to place an order to buy or sell a tradable object, a command to initiate managing orders according to a defined trading strategy, a command to change or cancel a previously submitted order (for example, modify a working order), an instruction to an electronic exchange relating to an order, or a combination thereof.

The trading device 110 may include one or more electronic computing platforms. For example, the trading device 110 may include a desktop computer, hand-held device, laptop, server, a portable computing device, a trading terminal, an embedded trading system, a workstation, an algorithmic trading system such as a “black box” or “grey box” system, cluster of computers, or a combination thereof. As another example, the trading device 110 may include a single or multi-core processor in communication with a memory or other storage medium configured to accessibly store one or more computer programs, applications, libraries, computer readable instructions, and the like, for execution by the processor.

As used herein, the phrases “configured to” and “adapted to” encompass that an element, structure, or device has been modified, arranged, changed, or varied to perform a specific function or for a specific purpose.

By way of example, the trading device 110 may be implemented as a personal computer running a copy of X_TRADER®, an electronic trading platform provided by Trading Technologies International, Inc. of Chicago, Ill. (“Trading Technologies”). As another example, the trading device 110 may be a server running a trading application providing automated trading tools such as ADL™, AUTOSPREADER®, and/or AUTOTRADER™, also provided by Trading Technologies. In yet another example, the trading device 110 may include a trading terminal in communication with a server, where collectively the trading terminal and the server are the trading device 110.

The trading device 110 is generally owned, operated, controlled, programmed, configured, or otherwise used by a user. As used herein, the phrase “user” may include, but is not limited to, a human (for example, a trader), trading group (for example, group of traders), or an electronic trading device (for example, an algorithmic trading system). One or more users may be involved in the ownership, operation, control, programming, configuration, or other use, for example.

The trading device 110 may include one or more trading applications. As used herein, a trading application is an application that facilitates or improves electronic trading. A trading application provides one or more electronic trading tools. For example, a trading application stored by a trading device may be executed to arrange and display market data in one or more trading windows. In another example, a trading application may include an automated spread trading application providing spread trading tools. In yet another example, a trading application may include an algorithmic trading application that automatically processes an algorithm and performs certain actions, such as placing an order, modifying an existing order, deleting an order. In yet another example, a trading application may provide one or more trading screens. A trading screen may provide one or more trading tools that allow interaction with one or more markets. For example, a trading tool may allow a user to obtain and view market data, set order entry parameters, submit order messages to an exchange, deploy trading algorithms, and/or monitor positions while implementing various trading strategies. The electronic trading tools provided by the trading application may always be available or may be available only in certain configurations or operating modes of the trading application.

A trading application may include computer readable instructions that are stored in a computer readable medium and executable by a processor. A computer readable medium may include various types of volatile and non-volatile storage media, including, for example, random access memory, read-only memory, programmable read-only memory, electrically programmable read-only memory, electrically erasable read-only memory, flash memory, any combination thereof, or any other tangible data storage device. As used herein, the term non-transitory or tangible computer readable medium is expressly defined to include any type of computer readable storage media and to exclude propagating signals.

One or more components or modules of a trading application may be loaded into the computer readable medium of the trading device 110 from another computer readable medium. For example, the trading application (or updates to the trading application) may be stored by a manufacturer, developer, or publisher on one or more CDs or DVDs, which are then loaded onto the trading device 110 or to a server from which the trading device 110 retrieves the trading application. As another example, the trading device 110 may receive the trading application (or updates to the trading application) from a server, for example, via the Internet or an internal network. The trading device 110 may receive the trading application or updates when requested by the trading device 110 (for example, “pull distribution”) and/or un-requested by the trading device 110 (for example, “push distribution”).

The trading device 110 may be adapted to send order messages. For example, the order messages may be sent to through the gateway 120 to the exchange 130. As another example, the trading device 110 may be adapted to send order messages to a simulated exchange in a simulation environment which does not effectuate real-world trades.

The order messages may be sent at the request of a user. For example, a trader may utilize the trading device 110 to send an order message or manually input one or more parameters for a trade order (for example, an order price and/or quantity). As another example, an automated trading tool provided by a trading application may calculate one or more parameters for a trade order and automatically send the order message. In some instances, an automated trading tool may prepare the order message to be sent but not actually send it without confirmation from a user.

An order message may be sent in one or more data packets or through a shared memory system. For example, an order message may be sent from the trading device 110 to the exchange 130 through the gateway 120. The trading device 110 may communicate with the gateway 120 using a local area network, a wide area network, a wireless network, a virtual private network, a T1 line, a T3 line, an integrated services digital network (“ISDN”) line, a point-of-presence, the Internet, and/or a shared memory system, for example.

The gateway 120 may include one or more electronic computing platforms. For example, the gateway 120 may implemented as one or more desktop computer, hand-held device, laptop, server, a portable computing device, a trading terminal, an embedded trading system, workstation with a single or multi-core processor, an algorithmic trading system such as a “black box” or “grey box” system, cluster of computers, or any combination thereof.

The gateway 120 may facilitate communication. For example, the gateway 120 may perform protocol translation for data communicated between the trading device 110 and the exchange 130. The gateway 120 may process an order message received from the trading device 110 into a data format understood by the exchange 130, for example. Similarly, the gateway 120 may transform market data in an exchange-specific format received from the exchange 130 into a format understood by the trading device 110, for example.

The gateway 120 may include a trading application, similar to the trading applications discussed above, that facilitates or improves electronic trading. For example, the gateway 120 may include a trading application that tracks orders from the trading device 110 and updates the status of the order based on fill confirmations received from the exchange 130. As another example, the gateway 120 may include a trading application that coalesces market data from the exchange 130 and provides it to the trading device 110. In yet another example, the gateway 120 may include a trading application that provides risk processing, calculates implieds, handles order processing, handles market data processing, or a combination thereof.

In certain embodiments, the gateway 120 communicates with the exchange 130 using a local area network, a wide area network, a virtual private network, a T1 line, a T3 line, an ISDN line, a point-of-presence, the Internet, and/or a shared memory system, for example.

The exchange 130 may be owned, operated, controlled, or used by an exchange entity. Example exchange entities include the CME Group, the London International Financial Futures and Options Exchange, the Intercontinental Exchange, and Eurex. The exchange 130 may include an electronic matching system, such as a computer, server, or other computing device, which is adapted to allow tradable objects, for example, offered for trading by the exchange, to be bought and sold. The exchange 130 may include separate entities, some of which list and/or administer tradable objects and others which receive and match orders, for example. The exchange 130 may include an electronic communication network (“ECN”), for example.

The exchange 130 may be an electronic exchange. The exchange 130 is adapted to receive order messages and match contra-side trade orders to buy and sell tradable objects. Unmatched trade orders may be listed for trading by the exchange 130. The trade orders may include trade orders received from the trading device 110 or other devices in communication with the exchange 130, for example. For example, typically the exchange 130 will be in communication with a variety of other trading devices (which may be similar to trading device 110) which also provide trade orders to be matched.

The exchange 130 is adapted to provide market data. Market data may be provided in one or more messages or data packets or through a shared memory system. For example, the exchange 130 may publish a data feed to subscribing devices, such as the trading device 110 or gateway 120. The data feed may include market data.

The system 100 may include additional, different, or fewer components. For example, the system 100 may include multiple trading devices, gateways, and/or exchanges. In another example, the system 100 may include other communication devices, such as middleware, firewalls, hubs, switches, routers, servers, exchange-specific communication equipment, modems, security managers, and/or encryption/decryption devices.

### III. EXPANDED EXAMPLE ELECTRONIC TRADING SYSTEM

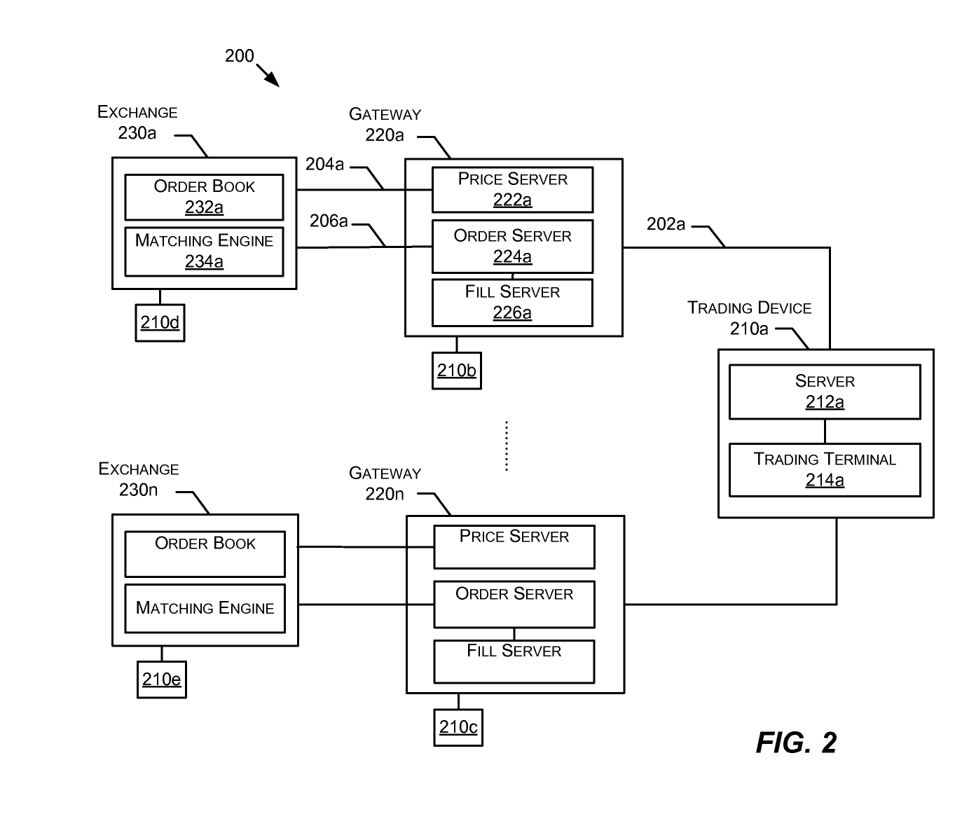

FIG. 2 illustrates a block diagram of another example electronic trading system 200 in which certain embodiments may be employed. In this example, a trading device 210a is in communication with an exchange 230a through a gateway 220a. The following discussion mainly focuses on the trading device 210a, gateway 220a, and the exchange 230a. However, the trading device 210a may also be connected to and communicate with any number of gateways 220n connected to exchanges 230n. The communication between the trading device 110a and other exchanges 230n may be the same, similar, or different than the communication between the trading device 210a and exchange 230a. Generally, each exchange has its own preferred techniques and/or formats for communicating with a trading device, a gateway, the user, or another exchange.

The trading device 210a, which may be similar to the trading device 110 in FIG. 1, may include a server 212a in communication with a trading terminal 214a. The server 212a may be located geographically closer to the gateway 120 than the trading terminal 214a. As a result, the server 212a latency benefits that are not afforded to the trading terminal 214a. In operation, the trading terminal 214a may provide a trading screen to a user and communicate commands to the server 212a for further processing. For example, a trading algorithm may be deployed to the server 212a for execution based on market data. The server 212a may execute the trading algorithm without further input from the user. In another example, the server 212a may include a trading application providing automated trading tools and communicate back to the trading terminal 214a. The trading device 210a may include, additional, different, or fewer components.

The trading device 210a may communicate with the gateway 220a using one or more communication networks. As used herein, a communication network is any network, including the Internet, which facilitates or enables communication between, for example, the trading device 210a, the gateway 220a and the exchange 220a. For example, as shown in FIG. 2, the trading device 210a may communicate with the gateway 220a across a multicast communication network 202a. The data on the network 202a may be logically separated by subject (for example, prices, orders, or fills). As a result, the server 212a and trading terminal 214a can subscribe to and receive data (for example, data relating to prices, orders, or fills) depending on their individual needs.

The gateway 220a, which may be similar to the gateway 120 of FIG. 1, may include a price server 222a, order server 224a, and fill server 226a. The gateway 220a may include additional, different, or fewer components. The price server 222a may process price data. Price data includes data related to a market for one or more tradable objects. The order server 224a may process order data. Order data is data related to a user's trade orders. For example, order data may include order messages, confirmation messages, or other types of messages. The fill server collects and provides fill data. Fill data includes data relating to one or more fills of trade orders. For example, the fill server 226a may provide a record of trade orders, which have been routed through the order server 224a, that have and have not been filled. The servers 222a, 224a, 226a may run on the same machine or separate machines.

The gateway 220a may communicate with the exchange 230a using one or more communication networks. For example, as shown in FIG. 2, there may be two communication networks connecting the gateway 220a and the exchange 230a. The network 204a may be used to communicate market data to the price server 222a. In some instances, the exchange 230a may include this data in a data feed that is published to subscribing devices. The network 206a may be used to communicate order data.

The exchange 230a, which may be similar to the exchange 130 of FIG. 1, may include an order book 232a and a matching engine 234a. The exchange 230a may include additional, different, or fewer components. The order book 232a is a database that includes data relating to unmatched quantity of trade orders. For example, an order book may include data relating to a market for a tradable object, such as the inside market, market depth at various price levels, the last traded price, and the last traded quantity. The matching engine 234a may match contra-side bids and offers. For example, the matching engine 234a may execute one or more matching algorithms that match contra-side bids and offers. A sell order is contra-side to a buy order with the same price. Similarly, a buy order is contra-side to a sell order with the same price.

In operation, the exchange 230a may provide price data from the order book 232a to the price server 222a and order data and/or fill data from the matching engine 234a to the order server 224a. Servers 222a, 224a, 226a may translate and communicate this data back to the trading device 210a. The trading device 210a, for example, using a trading application, may process this data. For example, the data may be displayed to a user. In another example, the data may be utilized in a trading algorithm to determine whether a trade order should be submitted to the exchange 230a. The trading device 210a may prepare and send an order message to the exchange 230a.

In certain embodiments, the gateway 220a is part of the trading device 210a. For example, the components of the gateway 220a may be part of the same computing platform as the trading device 210a. As another example, the functionality of the gateway 220a may be performed by components of the trading device 210a. In certain embodiments, the gateway 220a is not present. Such an arrangement may occur when the trading device 210a does not need to utilize the gateway 220a to communicate with the exchange 230a, for example. For example, if the trading device 210a has been adapted to communicate directly with the exchange 230a.

Additional trading devices 210b-210e, which are similar to trading device 210a, may be connected to one or more of the gateways 220a-220n and exchanges 230a-230n. Furthermore, additional gateways, similar to the gateway 220a, may be in communication with multiple exchanges, similar to the exchange 230a. Each gateway may be in communication with one or more different exchanges, for example. Such an arrangement may, for example, allow one or more trading devices 210a to trade at more than one exchange (and/or provide redundant connections to multiple exchanges).

### IV. EXAMPLE COMPUTING DEVICE

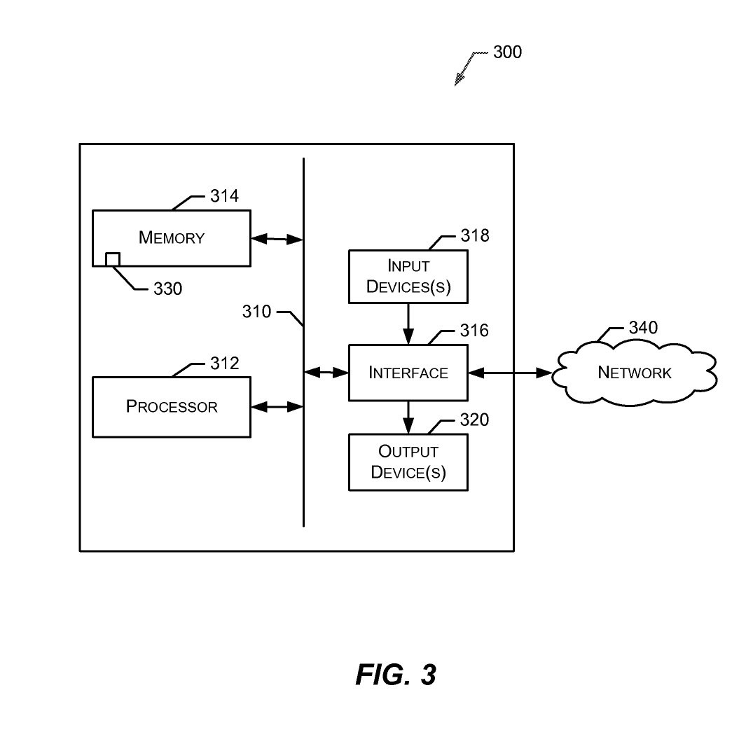

FIG. 3 illustrates a block diagram of an example computing device 300 which may be used to implement the disclosed embodiments. The trading device 110 of FIG. 1 may include one or more computing devices 300, for example. The gateway 120 of FIG. 1 may include one or more computing devices 300, for example. The exchange 130 of FIG. 1 may include one or more computing devices 300, for example.

The computing device 300 includes a communication network 310, a processor 312, a memory 314, an interface 316, an input device 318, and an output device 320. The computing device 300 may include additional, different, or fewer components. For example, multiple communication networks, multiple processors, multiple memory, multiple interfaces, multiple input devices, multiple output devices, or any combination thereof, may be provided. As another example, the computing device 300 may not include an input device 318 or output device 320.

As shown in FIG. 3, the computing device 300 may include a processor 312 coupled to a communication network 310. The communication network 310 may include a communication bus, channel, electrical or optical network, circuit, switch, fabric, or other mechanism for communicating data between components in the computing device 300. The communication network 310 may be communicatively coupled with and transfer data between any of the components of the computing device 300.

The processor 312 may be any suitable processor, processing unit, or microprocessor. The processor 312 may include one or more general processors, digital signal processors, application specific integrated circuits, field programmable gate arrays, analog circuits, digital circuits, programmed processors, and/or combinations thereof, for example. The processor 312 may be a single device or a combination of devices, such as one or more devices associated with a network or distributed processing. Any processing strategy may be used, such as multi-processing, multi-tasking, parallel processing, and/or remote processing. Processing may be local or remote and may be moved from one processor to another processor. In certain embodiments, the computing device 300 is a multi-processor system and, thus, may include one or more additional processors which are communicatively coupled to the communication network 310.

The processor 312 may be operable to execute logic and other computer readable instructions encoded in one or more tangible media, such as the memory 314. As used herein, logic encoded in one or more tangible media includes instructions which may be executable by the processor 312 or a different processor. The logic may be stored as part of software, hardware, integrated circuits, firmware, and/or micro-code, for example. The logic may be received from an external communication device via a communication network such as the network 340. The processor 312 may execute the logic to perform the functions, acts, or tasks illustrated in the figures or described herein.

The memory 314 may be one or more tangible media, such as computer readable storage media, for example. Computer readable storage media may include various types of volatile and non-volatile storage media, including, for example, random access memory, read-only memory, programmable read-only memory, electrically programmable read-only memory, electrically erasable read-only memory, flash memory, any combination thereof, or any other tangible data storage device. As used herein, the term non-transitory or tangible computer readable medium is expressly defined to include any type of computer readable medium and to exclude propagating signals. The memory 314 may include any desired type of mass storage device including hard disk drives, optical media, magnetic tape or disk, etc.

The memory 314 may include one or more memory devices. For example, the memory 314 may include local memory, a mass storage device, volatile memory, non-volatile memory, or a combination thereof. The memory 314 may be adjacent to, part of, programmed with, networked with, and/or remote from processor 312, so the data stored in the memory 314 may be retrieved and processed by the processor 312, for example. The memory 314 may store instructions which are executable by the processor 312. The instructions may be executed to perform one or more of the acts or functions described herein or shown in the figures.

The memory 314 may store a trading application 330. In certain embodiments, the trading application 330 may be accessed from or stored in different locations. The processor 312 may access the trading application 330 stored in the memory 314 and execute computer-readable instructions included in the trading application 330.

In certain embodiments, during an installation process, the trading application may be transferred from the input device 318 and/or the network 340 to the memory 314. When the computing device 300 is running or preparing to run the trading application 330, the processor 312 may retrieve the instructions from the memory 314 via the communication network 310.

### V. VARIABLE-BASED INCREMENT ADJUSTMENT

Prices (e.g., bid prices and/or ask prices) may be set at a variety of different price levels. Particular markets and/or exchanges may implement a tick size or increment to define a smallest tradable price level graduation in a market. For example, a tick or increment may represent a fraction of a dollar (e.g., one cent) or another currency, or a tick or increment may represent a decimal portion of a dollar or another currency. Trading interfaces, trading strategies, and/or markets may implement a particular trading increment; however, it is desirable to provide automatic adjustment of increment settings based on different variables.

Examples disclosed herein enable variable-based increment adjustment. In examples disclosed herein, increment adjustment rules are defined to specify particular market conditions and/or trading conditions and how trading increments are to be implemented during such market conditions and/or trading conditions. Increment adjustment rules may be specified by a definition which includes logic expressions and/or parameters that describe particular market conditions and/or trading conditions. Market conditions may relate to market volatility, volume (e.g., trade size) in the market, etc. For example, a market may be volatile in that prices are moving quickly over time. Increment adjustment rules may define market volatility as a particular amount of price change over a particular amount of time. Volatility may also be based off of a net change, or a net percent change, in price (e.g., a net change in price on a particular day). Varying levels of market volatility may be defined and different trading increments may be associated with each level of market volatility. Market data may be analyzed to determine if a market is volatile (e.g., to determine if prices are changing too quickly according to an increment adjustment rule). In some example, trade sizes may be so large as to redefine risk in a market for a trader. Trading conditions may relate to individual position size, position size of a firm, previously entered order sizes, etc. For example, trades may be made at a particular size (e.g., 100,000 shares) and then trades may be made at a different size (e.g., 1 million shares).

Some examples disclosed herein alter increments in a trading interface. Increment adjustment rules are defined to specify how increments are to be displayed in the trading interface based on market conditions and/or trading conditions. When particular market conditions and/or trading conditions occur, particular increments are displayed in the trading interface. When the market conditions and/or trading conditions change, the increments of the trading interface are adjusted in accordance with the increment adjustment rules. For example, an increment adjustment rule may specify that when a market is non-volatile, increments are set to 0.01 and when the market is volatile, increments are set to 0.05. In a trading interface displaying a market depth ladder, when the market is non-volatile, the increments at the market depth ladder are 0.01. When the market becomes volatile, the increments at the market depth ladder are automatically adjusted to 0.05.

Some examples disclosed herein alter increments in a trading strategy. Increment adjustment rules are defined to specify how increments are to affect trading strategies (e.g., a trading algorithm) based on market conditions and/or trading conditions. When particular market conditions and/or trading conditions occur, particular increments are implemented in the trading algorithm. When the market conditions and/or trading conditions change, the increments implemented in the trading algorithm are adjusted in accordance with the increment adjustment rules. For example, an increment adjustment rule may specify that when a market is non-volatile, increments are set to 1x, where x is an increment set by an exchange, and that when the market is volatile, increments are set to 5x. For a trading algorithm being executed at a trading device, when the market is non-volatile, the increments in the trading algorithm are 1x. When the market becomes volatile, the increments in the trading algorithm are 5x.

Some examples disclosed herein alter increments in a market. Increment adjustment rules are defined to specify how increments are to be implemented in a market based on market conditions. When particular market conditions occur, particular increments are implemented by an exchange in the market. When the market conditions change, the increments implemented by the exchange in the market are adjusted in accordance with the increment adjustment rules. For example, an increment adjustment rule may specify that when a market is non-volatile, increments are set to 0.001, and that when the market is volatile, increments are set to 0.01. When the market is non-volatile, the increment for the market is broadcast as 0.001. Alternatively, when the market is non-volatile, the exchange accepts orders on increments of 0.001. When the market is volatile, the increment for the market is broadcast as 0.01. Alternatively, when the market is volatile, the exchange accepts orders on increments of 0.01. For example, the exchange recognizes an order at a price of $4.01, not at a price of $4.011. If orders are submitted at a price not recognized by the exchange during the particular market conditions, the exchange may round the price to the nearest increment as defined by the increment adjustment rule.

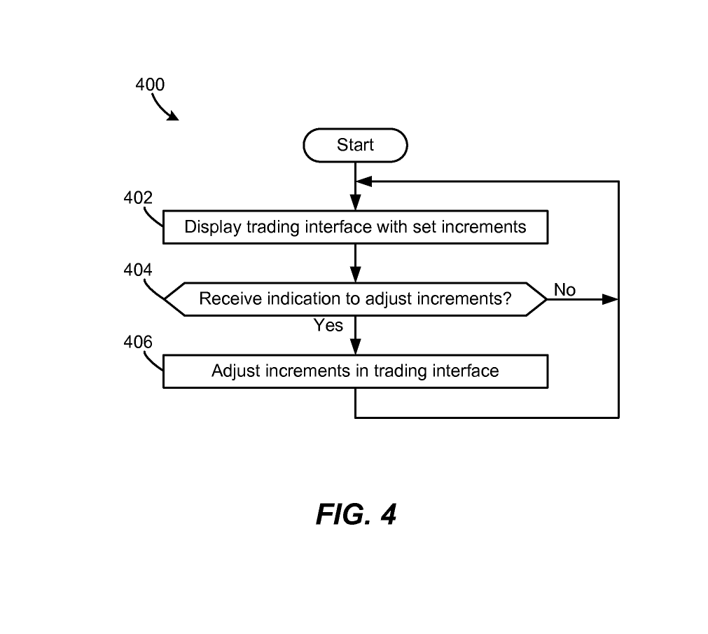

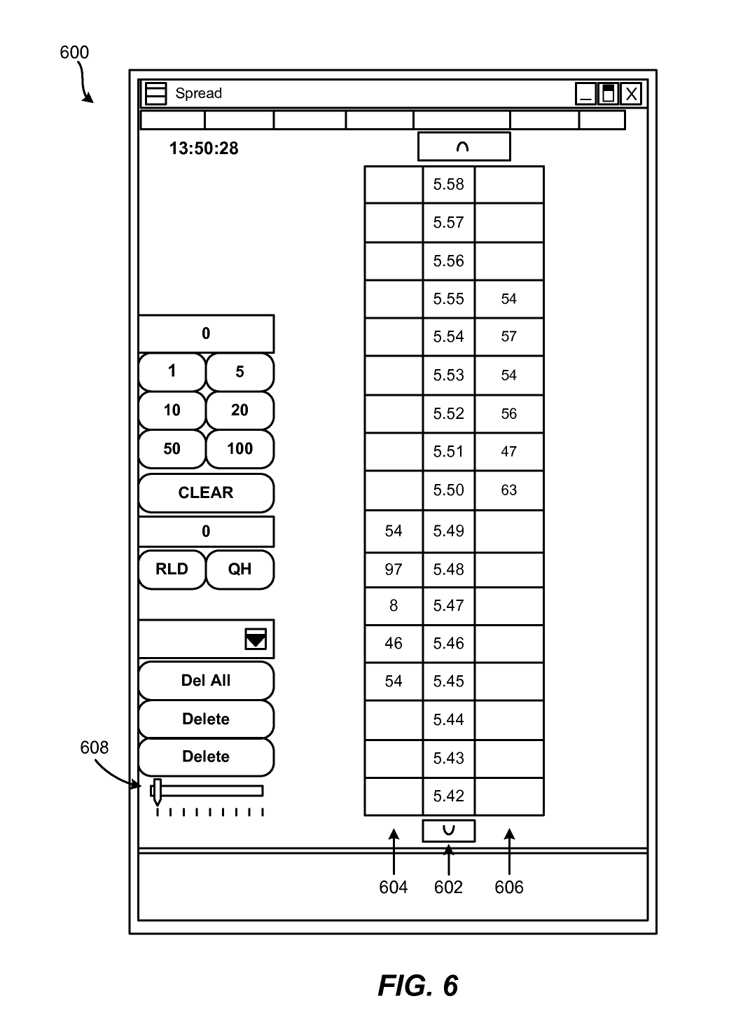

FIG. 4 illustrates a flow diagram of an example method 400 for facilitating increment adjustment on a trading interface. An example trading interface is illustrated below in connection with FIG. 6. In the illustrated example, a user (e.g., a trader) implements increment adjustment in the trading interface (e.g., including a market depth ladder) using a slide bar displayed in the trading interface. Slide bars are discussed in U.S. Pat. No. 7,577,602, entitled “Method and Interface for Consolidating Price Levels on a Trading Screen,” filed on Nov. 26, 2002, and issued on Aug. 18, 2009; U.S. Pat. No. 7,577,607, entitled “Method and Interface for Consolidating Price Levels on a Trading Screen,” filed on May 2, 2006, and issued on Aug. 18, 2009; U.S. Pat. No. 7,844,532, entitled “Method and Interface for Consolidating Price Levels on a Trading Screen,” filed on Jul. 14, 2009, and issued on Nov. 30, 2010; U.S. Pat. No. 8,195,554, entitled “Method an Interface for Consolidating Price Levels on a Trading Screen,” filed on Oct. 19, 2010, and issued on Jun. 5, 2012; and U.S. patent application Ser. No. 13/454,586, entitled “Method and Interface for Consolidating Price Levels on a Trading Screen,” and filed on Apr. 24, 2012, each of which are herein incorporated by reference in their entireties.

Initially, an example increment adjustment system displays a trading interface with set increments (e.g., 0.01) (block 402). The example increment adjustment system determines if an indication to adjust the increments has been received from the trader (block 404). The indication is provided to the example increment adjustment system when the trader utilizes the slide bar in the trading interface. If an indication to adjust the increments is not received, control returns to block 402. If an indication to adjust the increments is received, the example increment adjustment system adjusts the increments in the trading interface (block 406). The increments are adjusted according the increments selected by the trader via the slide bar. To adjust the increments in the trading interface, the example increment adjustment system consolidates prices so that prices are shown in the desired range. For example, prices may be at 0.001 increments, but may be consolidated such that the prices are displayed at 0.01 increments. Consolidating prices in accordance with a particular increment does not affect how increments are implemented by a market and/or exchange, but rather facilities ease of use of the trading interface by the trader. Once the increments have been adjusted in the trading interface, control returns to block 402.

In some examples, a switch is used to adjust the increments in the trading interface. For example, when the switch is “off” the market may be non-volatile and a particular trading increment is used. A trader may turn the switch “on” to indicate that the market is volatile and different trading increments are to be implemented. The switch may be used in conjunction with the slide bar, or may replace the slide bar in a trading interface.

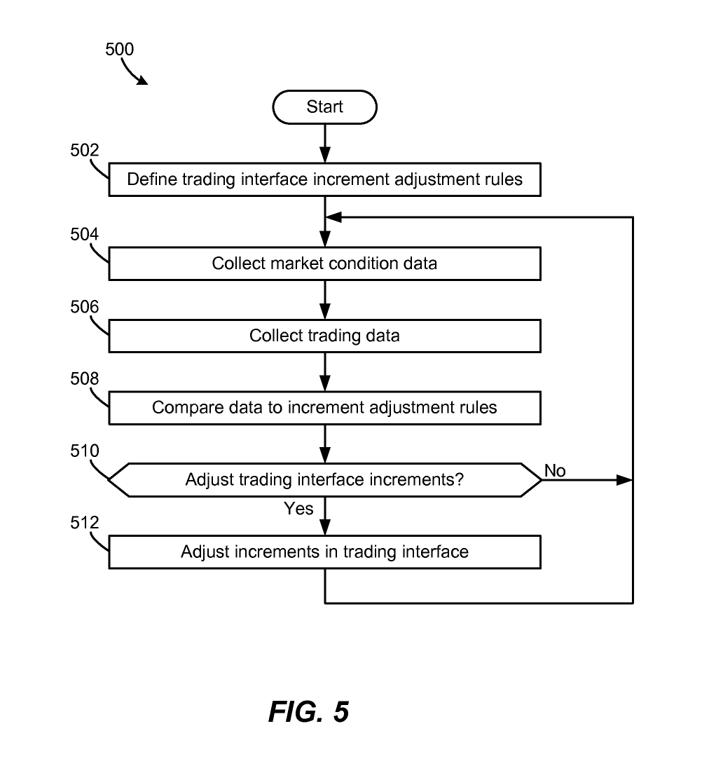

FIG. 5 illustrates a flow diagram of an example method 500 for facilitating variable-based increment adjustment on a trading interface. An example trading interface is illustrated below in connection with FIG. 6. In the illustrated example, an increment adjustment system automatically updates a trading interface (e.g., including a market depth ladder) based on increment adjustment rules. Initially, trading interface increment adjustment rules are defined (block 502). Trading interface increment adjustment rules are defined to specify how increments are to be displayed in the trading interface based on market conditions and/or trading conditions. Trading interface increment adjustment rules may be specified by a definition which includes logic expressions and/or parameters that describe particular market conditions and/or trading conditions. Market conditions may relate to market volatility, volume (e.g., trade size) in the market, etc. Trading conditions may relate to individual position size, position size of a firm, previously entered order sizes, etc. The trading interface increment adjustment rules specify particular increments for particular incidents of market and/or trading conditions. For example, a trading interface increment adjustment rule may specify that when a market is non-volatile, increments are set to 0.01, and when the market is volatile, increments are set to 0.05.

The example increment adjustment system collects market condition data (block 504). Market condition data is collected by the example increment adjustment system from an exchange associated with the trading interface (e.g., a market the trading interface is facilitating trading in). Additionally or alternatively, the example increment adjustment system collects market condition data by analyzing market data received from the exchange. Market condition data relates to volatility of the market and/or sizes of trades being placed in the market.

The example increment adjustment system collects trading data (block 506). Trading data is collected by the example increment adjustment system from a trading device associated with the trading interface (e.g., a trading device that implements the trading interface). Additionally or alternatively, the example increment adjustment system collects trading data by analyzing data from the trading device. Trading data relates to individual position size (e.g., position size for the current day), overall position size of a firm, previously entered order sizes, etc.

The example increment adjustment system compares the market condition data and/or trading data to the trading interface increment adjustment rules (block 508). The market condition data and/or trading data may be formed into data structures for comparison with the logic expressions and/or parameters of the trading interface increment adjustment rules.

The example increment adjustment system determines whether to adjust the increments of the trading interface based on the comparison (block 510). For example, if the market condition data reflects that market conditions exist as defined in a trading interface increment adjustment rule, the example increment adjustment system determines that increments of the trading interface are to be adjusted according to the trading interface increment adjustment rule. If the trading data reflects that trading is being implemented as defined in a trading interface increment adjustment rule, the example increment adjustment system determines that increments of the trading interface are to be adjusted according the trading interface increment adjustment rule. If the market condition data reflects that market conditions do not exist as defined in a trading interface increment adjustment rule, the example increment adjustment system determines that the increments of the trading interface are not to be adjusted and control returns to block 504. If the trading data reflects that trading is not being implemented as defined in a trading interface increment adjustment rule, the example increment adjustment system determines that the increments of the trading interface are not to be adjusted and control returns to block 504.

If the example increment adjustment system determines that the increments of the trading interface are to be adjusted (block 510), the example increment adjustment system adjusts the increments in the trading interface in accordance with the trading interface increment adjustment rule (block 512). For example, the example increment adjustment system may adjust an increment of a market depth ladder set at 0.01 when the market is non-volatile to 0.05 when the market becomes volatile. Once the increments of the trading interface have been adjusted, control returns to block 504.

FIG. 6 illustrates an example trading interface 600 implemented using the methods of FIGS. 4 and/or 5. The example trading interface 600 reflects price information related to a tradable object available at an exchange. Different price levels are shown in a price level column 602. Increments of 0.01 are implemented in the example of FIG. 6, although other example increments include 0.05 and 0.001. Buy and sell bid quantity columns 604 and 606 immediately adjacent the price level column 602 represent quantity information disseminated by the exchange. As shown in FIG. 6, the exchange indicates that a bid quantity of fifty-four (54) is present at the price level of $5.49, that a bid quantity of ninety-seven (97) is present at the price level of $5.48, and so on. Further, the exchange 130 indicates that a sell quantity of sixty-three (63) is present at the price level of $5.50, that a sell quantity of forty-seven (47) is present at the price level of $5.51, and so on.

Tools are provided by the example increment adjustment system to adjust the increments shown in the example trading interface 600. A slide bar 608 is provided in the example trading interface 600 in accordance with the method 400 of FIG. 4 to allow a trader to adjust the price increments used in the price level column 602. If the trader moves the slide bar 608, an example increment adjustment system updates the increments shown in the price level column 602. A switch may additionally or alternatively be used to adjust the increments shown in the price level column 602. In some examples, when the switch is “off,” a particular trading increment may be implemented in the trading interface 600, and when the switch is “on,” a different trading increment may be implemented. For example, when the switch is “off” the market may be non-volatile and a particular trading increment is used. A trader may turn the switch “on” to indicate that the market is volatile and different trading increments are to be implemented.

A user may also select (e.g., stretch, drag, etc.) one or more price levels and/or the price level column 602 to adjust the increments shown in the price level column 602. For example, if the user selects the price level and drags the price level down (e.g., toward the bottom of the trading interface 600), the price level column 602 is consolidated, and if the user selects the price level and drags the price level up (e.g., toward the top of the trading interface 600), the price column 602 is separated. The tools provided by the example increment adjustment system enable user-control of the trading interface 600.

Additionally or alternatively, programmatic control of the trading interface 600 may be provided by the example increment adjustment system. For example, the example increment adjustment system may update the increments automatically according to trading interface increment adjustment rules as described in the method 500 of FIG. 5. For example, the example increment adjustment system may automatically determine that the market has become volatile and adjust (e.g., consolidate) the increments in the trading interface 600 according to the trading interface increment adjustment rules. The example increment adjustment system may provide, for example, a series of drop-down boxes, selectable settings, etc. via the trading interface 600 to allow a user to define the trading interface increment adjustment rules and/or the tools to be used to adjust the trading increments.

Any of the tools and/or programmatic controls may be used to adjust the increments implemented in the trading interface 600. For example, any of the tools and/or programmatic controls may be used to increase the trading increment of 0.01 shown in FIG. 6 to the trading increment of 0.05. The example increment adjustment system consolidates the buy and sell bids according to the adjusted increment. For example, if the increment is adjusted to 0.05, a total of 331 (e.g., 54+57+54+56+47+63) sell quantities will be displayed in the sell bid quantity column 606 at the price level $5.50 in the price level column 602. A total of 259 (e.g., 54+97+8+46+54) buy quantities will be displayed in the buy quantity column 604 at the price level $5.45 in the price level column 602.

In another example, the trading increment of 0.01 shown in FIG. 6 may be decreased to the trading increment of 0.001. The example increment adjustment system separates the buy and sell bids according to the adjusted increments. For example, if the increment is adjusted to 0.001, the sell quantity of 63 at the price level of $5.50 in FIG. 6 becomes a sell quantity of 23 at a price level of $5.500 and a sell quantity of 40 at a price level of $5.505. The buy quantity of 54 at the price level of $5.49 of FIG. 6 becomes a buy quantity of 33 at a price level of $5.495 and a buy quantity of 21 at a price level of $5.490.

One or more tools and/or programmatic controls may be used to adjust the increments implemented in the trading interface 600. For example, the example increment adjustment system may determine that the market has become volatile and implement the trading increment of 0.05, and a user may then use the slide bar 608 to adjust the trading increment to 0.01, as illustrated in FIG. 6.

In some examples, the trading interface 600 may include a display of market information (e.g., market volatility) provided by an exchange to allow a user to reference the information when adjusting the trading increments via the tools in the trading interface 600. The example increment adjustment system may also use this market information to automatically adjust the trading increments at the trading interface 600.

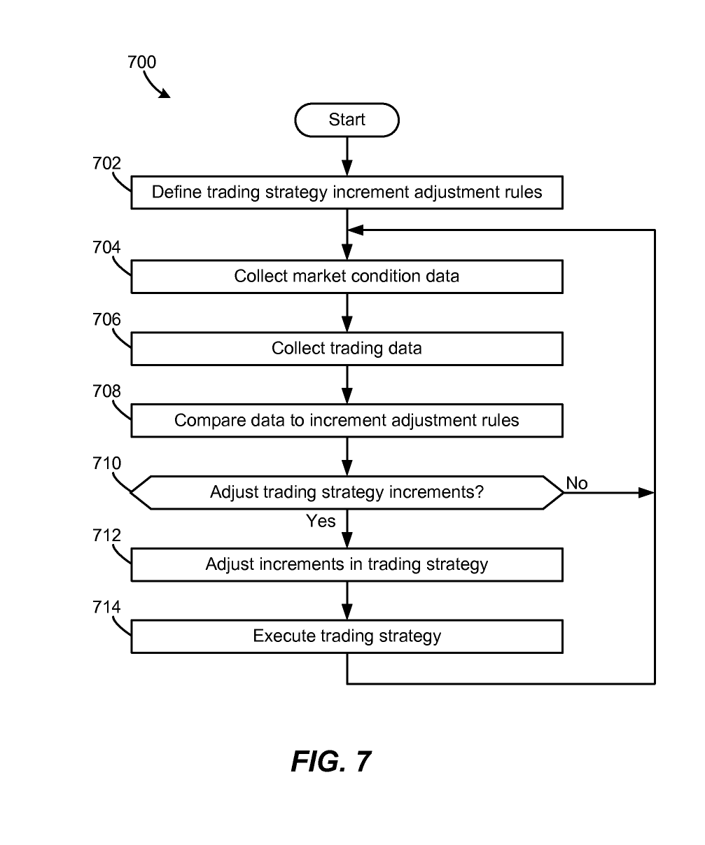

FIG. 7 illustrates a flow diagram of an example method 700 for facilitating variable-based increment adjustment in a trading strategy. In the illustrated example, an increment adjustment system automatically updates a trading strategy (e.g., a trading algorithm) based on trading strategy increment adjustment rules. Initially, trading strategy increment adjustment rules are defined (block 702). Trading strategy increment adjustment rules are defined to specify how increments are to affect trading strategies (e.g., trading algorithms) based on market conditions and/or trading conditions. Trading strategy increment adjustment rules may be specified by a definition which includes logic expressions and/or parameters that describe particular market conditions and/or trading conditions. Market conditions may relate to market volatility, volume (e.g., trade size) in the market. Trading conditions may relate to individual position size, position size of a firm, previously entered order sizes, etc. The trading interface increment adjustment rules specify particular increments for particular incidents of market and/or trading conditions. For example, a trading strategy increment adjustment rule may specify that when a market is non-volatile, increments are set to 1x, where x is an increment set by an exchange, and that when the market is volatile, increments are set to 5x. For example, a trading algorithm may specify that when a market is non-volatile, an ask price is to be 1x increments above a buy price. The trading algorithm may specify that when a market is volatile, an ask price is to be 5x increments above a buy price.

The example increment adjustment system collects market condition data (block 704). Market condition data is collected by the example increment adjustment system from an exchange associated with the trading interface (e.g., a market the trading interface is facilitating trading in). Additionally or alternatively, the example increment adjustment system collects market condition data by analyzing market data received from the exchange. Market condition data relates to volatility of the market and/or sizes of trades being placed in the market.

The example increment adjustment system collects trading data (block 706). Trading data is collected by the example increment adjustment system from a trading device associated with the trading interface (e.g., a trading device that implements the trading interface). Additionally or alternatively, the example increment adjustment system collects trading data by analyzing data from the trading device. Trading data relates to individual position size (e.g., position size for the current day), overall position size of a firm, previously entered order sizes, etc.

The example increment adjustment system compares the market condition data and/or trading data to the trading strategy increment adjustment rules (block 708). The market condition data and/or trading data may be formed into data structures for comparison with the logic expressions and/or parameters of the trading strategy increment adjustment rules.

The example increment adjustment system determines whether to adjust the increments of the trading strategy based on the comparison (block 710). For example, if the market condition data reflects that market conditions exist as defined in a trading strategy increment adjustment rule, the example increment adjustment system determines that increments of the trading strategy are to be adjusted according to the trading strategy increment adjustment rule. If the trading data reflects that trading is being implemented as defined in a trading strategy increment adjustment rule, the example increment adjustment system determines that increments of the trading strategy are to be adjusted according the trading strategy increment adjustment rule. If the market condition data reflects that market conditions do not exist as defined in a trading strategy increment adjustment rule, the example increment adjustment system determines that the increments of the trading strategy are not to be adjusted and control returns to block 704. If the trading data reflects that trading is not being implemented as defined in a trading strategy increment adjustment rule, the example increment adjustment system determines that the increments of the trading strategy are not to be adjusted and control returns to block 704.

If the example increment adjustment system determines that the increments of the trading strategy are to be adjusted (block 710), the example increment adjustment system adjusts the increments in the trading strategy in accordance with the trading strategy increment adjustment rule (block 712). For example, the example increment adjustment system may adjust an increment of a trading algorithm set at 1x when the market is non-volatile to 5x when the market becomes volatile. The example increment adjustment system then executes the trading strategy according to the adjusted increments (block 714). For example, the example increment adjustment system instructs the trading device to execute the trading algorithm to send orders to the exchange according to the adjusted increments. Once the example increment adjustment system executes the trading strategy, control returns to block 704.

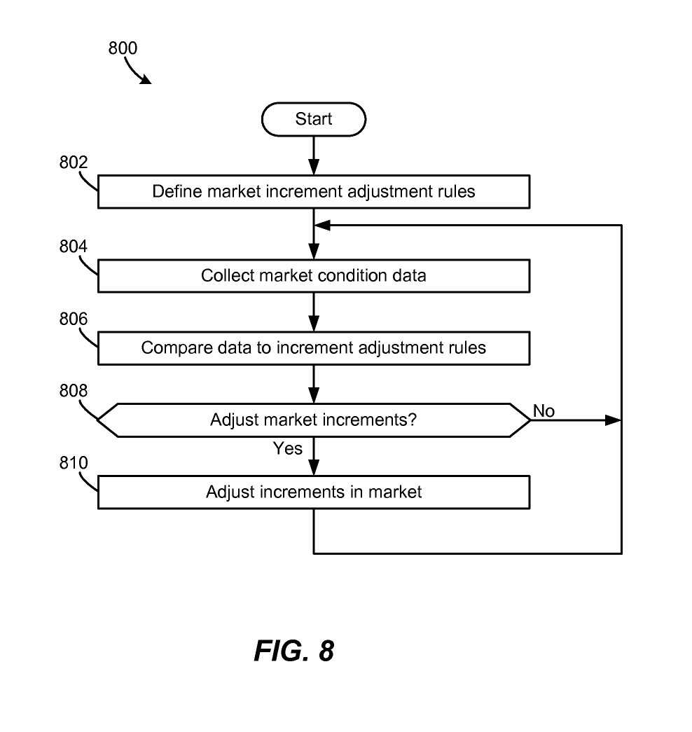

FIG. 8 illustrates a flow diagram of an example method 800 for facilitating variable-based increment adjustment in a market. In the illustrated example, an increment adjustment system automatically updates increments of a market (e.g., increments broadcast by a market to trading devices and/or increments acceptable to the market) based on market increment adjustment rules. Initially, market increment adjustment rules are defined (block 802). Market increment adjustment rules are defined to specify how increments are to be implemented in a market based on market conditions. Market increment adjustment rules may be specified by a definition which includes logic expressions and/or parameters that describe particular market conditions. Market conditions may relate to market volatility, volume (e.g., trade size) in the market. The market increment adjustment rules specify particular increments for particular incidents of market conditions. For example, a market increment adjustment rule may specify that when a market is non-volatile, increments are set to 0.001, and that when the market is volatile, increments are set to 0.01. When the market is non-volatile, the increment for the market is broadcast as 0.001. Alternatively, when the market is non-volatile, the exchange accepts orders on increments of 0.001. When the market is volatile, the increment for the market is broadcast as 0.01. Alternatively, when the market is volatile, the exchange accepts orders on increments of 0.01.

The example increment adjustment system collects market condition data (block 804). Market condition data is collected by the example increment adjustment system from an exchange associated with the trading interface (e.g., a market the trading interface is facilitating trading in). Additionally or alternatively, the example increment adjustment system collects market condition data by analyzing market data received from the exchange. Market condition data relates to volatility of the market and/or sizes of trades being placed in the market.

The example increment adjustment system compares the market condition data to the market increment adjustment rules (block 806). The market condition data may be formed into data structures for comparison with the logic expressions and/or parameters of the market increment adjustment rules.

The example increment adjustment system determines whether to adjust the increments of the market based on the comparison (block 808). For example, if the market condition data reflects that market conditions exist as defined in a market increment adjustment rule, the example increment adjustment system determines that increments of the market are to be adjusted according to the market increment adjustment rule. If the market condition data reflects that market conditions do not exist as defined in a market increment adjustment rule, the example increment adjustment system determines that the increments of the market are not to be adjusted and control returns to block 804.

If the example increment adjustment system determines that the increments of the market are to be adjusted (block 808), the example increment adjustment system adjusts the increments in the market in accordance with the market increment adjustment rule (block 810). For example, the example increment adjustment system may adjust an increment of a market from 0.0001 when the market is non-volatile to 0.001 when the market becomes volatile. The example increment adjustment system may broadcast the increments to trading devices to inform the trading devices and/or users of the trading devices of acceptable increments. Alternatively, the example increment adjustment system may accept only particular increments defined by the market increment adjustment rule. Once the increments of the market have been adjusted, control returns to block 804.

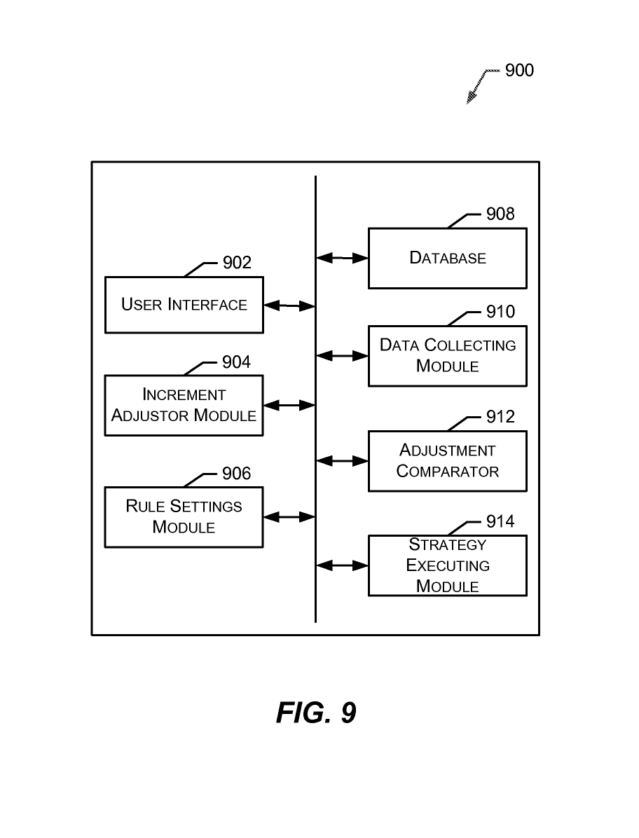

FIG. 9 illustrates a block diagram of an example increment adjustment system 900 to implement the methods of FIGS. 4, 5, 6, and/or 7. The example increment adjustment system 900 provides variable-based increment adjustments in trading interfaces, trading strategies, and/or markets. The example increment adjustment system 900 may be implemented at a trading device and/or at an exchange. The increment adjustment system 900 of the illustrated example includes an example user interface 902, an example increment adjustor module 904, an example rule settings module 906, an example database 908, an example data collecting module 910, an example adjustment comparator 912, and an example strategy executing module 914.

The example user interface 902 receives user (e.g., trader) indications to adjust increments in trading interfaces. For example, a user indication may be received by the example user interface 902 via a slide bar in the trading interface. The example increment adjustor module 904 adjusts increments of the trading interface in accordance with the indication received at the user interface 902. For example, the example increment adjustor module 904 may adjust an increment of a market depth ladder in a trading interface set at 0.01 to 0.05 when an indication is received by the example user interface 902.

The example rule settings module 906 facilitates defining of increment adjustment rules. Trading interface adjustment rules are defined to specify how increments are to be displayed on a trading interface based on market conditions and/or trading conditions. Trading strategy increment adjustment rules are defined to specify how increments are to affect trading strategies (e.g., trading algorithms) based on market conditions and/or trading conditions. Market increment adjustment rules are defined to specify how increments are to be implemented by exchanges based on market conditions. The increment adjustment rules may be specified by a definition which includes logic expressions and/or parameters that describe particular market conditions and/or trading conditions. Market conditions may relate to market volatility, volume (e.g., trade size) in the market. Trading conditions may relate to individual position size, position size of a firm, previously entered order sizes, etc. The increment adjustment rules specify particular increments for particular incidents of market and/or trading conditions. For example, a trading interface increment adjustment rule may specify that when a market is non-volatile, increments are set to 0.01, and when the market is volatile, increments are set to 0.05. A trading strategy increment adjustment rule may specify that when a market is non-volatile, increments are set to 1x, where x is an increment set by an exchange, and that when the market is volatile, increments are set to 5x. A market increment adjustment rule may specify that when a market is non-volatile, increments are set to 0.001, and that when the market is volatile, increments are set to 0.01. When the market is non-volatile, the increment for the market is broadcast as 0.001. Alternatively, when the market is non-volatile, the exchange accepts orders on increments of 0.001. When the market is volatile, the increment for the market is broadcast as 0.01. Alternatively, when the market is volatile, the exchange accepts orders on increments of 0.01.

Increment adjustment rules may be defined by users (e.g., traders, administrators, etc.) via the example rule settings module 906. Alternatively, increment adjustment rules may be set automatically (e.g., to default settings). The increment adjustment rules are stored in the database 908.

The example data collecting module 910 collects market condition data and/or trading data. Market condition data is collected by the example data collecting module 910 from an exchange associated with a trading interface (e.g., a market the trading interface is facilitating trading in). Additionally or alternatively, the example data collecting module 910 collects market condition data by analyzing market data received from the exchange. Market condition data relates to volatility of the market and/or sizes of trades being placed in the market. Trading data is collected by the example data collecting module 910 from a trading device associated with the trading interface (e.g., a trading device that implements the trading interface). Additionally or alternatively, the example data collecting module 910 collects trading data by analyzing data from the trading device. Trading data relates to individual position size (e.g., position size for the current day), overall position size of a firm, previously entered order sizes, etc.

The example adjustment comparator 912 compares the market condition data and/or trading data to the increment adjustment rules. The market condition data and/or trading data may be formed into data structures for comparison with the logic expressions and/or parameters of the trading strategy increment adjustment rules. The example adjustment comparator 912 determines whether to adjust the increments of the trading interface, trading strategy, and/or market based on the comparison. For example, if the market condition data reflects that market conditions exist as defined in an increment adjustment rule, the example adjustment comparator 912 determines that increments of the trading interface, trading strategy, and/or market are to be adjusted according to the increment adjustment rule. If the trading data reflects that trading is being implemented as defined in an increment adjustment rule, the example adjustment comparator 912 determines that increments of the trading interface, trading strategy, and/or market are to be adjusted according the increment adjustment rule. If the market condition data reflects that market conditions do not exist as defined in an increment adjustment rule, the example adjustment comparator 912 determines that the increments of the trading interface, trading strategy, and/or market are not to be adjusted. If the trading data reflects that trading is not being implemented as defined in an increment adjustment rule, the example adjustment comparator 912 determines that the increments of the trading device, trading strategy, and/or market are not to be adjusted.

If the example adjustment comparator 912 determines that the increments of the trading interface, trading strategy, and/or market are to be adjusted, the example increment adjustor module 904 adjusts the increments in the trading interface, trading strategy, and/or market in accordance with the increment adjustment rule. For example, the example increment adjustor module 904 may adjust an increment of a market depth ladder in a trading interface set at 0.01 when the market is non-volatile to 0.05 when the market becomes volatile. The example increment adjustor module 904 may adjust an increment of a trading algorithm set at 1x when the market is non-volatile to 5x when the market becomes volatile. The example increment adjustor module 904 may adjust an increment of a market from 0.0001 when the market is non-volatile to 0.001 when the market becomes volatile. The example increment adjustor module 904 may broadcast the increments to trading devices to inform the trading devices and/or users of the trading devices of acceptable increments. Alternatively, the example increment adjustor module 904 may accept only particular increments defined by the market increment adjustment rule.

The example strategy executing module 914 executes trading strategies according to increments and/or adjusted increments. For example, the example strategy executing module 914 instructs the trading device to execute the trading algorithm to send orders to the exchange according to the increments and/or adjusted increments.

Some of the described figures depict example block diagrams, systems, and/or flow diagrams representative of methods that may be used to implement all or part of certain embodiments. One or more of the components, elements, blocks, and/or functionality of the example block diagrams, systems, and/or flow diagrams may be implemented alone or in combination in hardware, firmware, discrete logic, as a set of computer readable instructions stored on a tangible computer readable medium, and/or any combinations thereof, for example.

The example block diagrams, systems, and/or flow diagrams may be implemented using any combination of application specific integrated circuit(s) (ASIC(s)), programmable logic device(s) (PLD(s)), field programmable logic device(s) (FPLD(s)), discrete logic, hardware, and/or firmware, for example. Also, some or all of the example methods may be implemented manually or in combination with the foregoing techniques, for example.

The example block diagrams, systems, and/or flow diagrams may be performed using one or more processors, controllers, and/or other processing devices, for example. For example, the examples may be implemented using coded instructions, for example, computer readable instructions, stored on a tangible computer readable medium. A tangible computer readable medium may include various types of volatile and non-volatile storage media, including, for example, random access memory (RAM), read-only memory (ROM), programmable read-only memory (PROM), electrically programmable read-only memory (EPROM), electrically erasable read-only memory (EEPROM), flash memory, a hard disk drive, optical media, magnetic tape, a file server, any other tangible data storage device, or any combination thereof. The tangible computer readable medium is non-transitory.

Further, although the example block diagrams, systems, and/or flow diagrams are described above with reference to the figures, other implementations may be employed. For example, the order of execution of the components, elements, blocks, and/or functionality may be changed and/or some of the components, elements, blocks, and/or functionality described may be changed, eliminated, sub-divided, or combined. Additionally, any or all of the components, elements, blocks, and/or functionality may be performed sequentially and/or in parallel by, for example, separate processing threads, processors, devices, discrete logic, and/or circuits.

While embodiments have been disclosed, various changes may be made and equivalents may be substituted. In addition, many modifications may be made to adapt a particular situation or material. Therefore, it is intended that the disclosed technology not be limited to the particular embodiments disclosed, but will include all embodiments falling within the scope of the appended claims.

1. A method comprising:
determining, using a computing device, whether to automatically adjust a first trading increment implemented in a trading interface to a second trading increment by monitoring for a condition related to activity in a trading market, the condition being defined in an increment adjustment rule by a user, the first trading increment and the second trading increment associated with trading prices in the trading market; and
adjusting, using the computing device, the first trading increment to the second trading increment implemented in the trading interface during the condition according to the increment adjustment rule.

2. The method of claim 1, wherein the increment adjustment rule includes at least one of a logic expression or parameter to define the condition.

3. The method of claim 1, wherein the condition includes at least one of market volatility, order size, or position size.

4. The method of claim 1, wherein monitoring for the condition defined in the increment adjustment rule includes collecting at least one of market condition data or trading data.

5. The method of claim 1, wherein the trading interface is used to execute trades in the trading market according to the trading prices.

6. The method of claim 1, further comprising adjusting a trading strategy used to execute trades in the trading market based on the second trading increment.

7. The method of claim 6, further comprising executing the trading strategy using the second trading increment.

8. The method of claim 1, further comprising broadcasting the second trading increment from an exchange to a trading device.

9. The method of claim 1, further comprising processing orders at an exchange using the second trading increment.

10. A system comprising:
an adjustment comparator device to determine whether to automatically adjust a first trading increment implemented in a trading interface to a second trading increment by monitoring for a condition related to activity in a trading market, the condition being defined in an increment adjustment rule by a user, the first trading increment and the second trading increment associated with trading prices in the trading market; and
an increment adjustor module device to adjust the first trading increment to the second trading increment implemented in the trading interface during the condition according to the increment adjustment rule.

11. The system of claim 10, wherein the trading interface is used to execute trades in the trading market according to the trading prices.

12. The system of claim 10, wherein the increment adjustor module device is to adjust a trading strategy used to execute trades in the trading market based on the second trading increment.

13. The system of claim 12, further comprising a strategy executing module device to execute the trading strategy using the second trading increment.

14. The system of claim 10, wherein the increment adjustor module device is to broadcast the second trading increment from an exchange to a trading device.

15. The system of claim 10, wherein the increment adjustor module device is to process orders at an exchange using the second trading increment.

16. A non-transitory tangible computer-readable storage medium comprising instructions that, when executed, cause a computing device to carry out acts comprising:
determining whether to automatically adjust a first trading increment implemented in a trading interface to a second trading increment by monitoring for a condition related to activity in a trading market, the condition being defined in an increment adjustment rule by a user, the first trading increment and the second trading increment associated with trading prices in the trading market; and
adjusting the first trading increment to the second trading increment implemented in the trading interface during the condition according to the increment adjustment rule.

17. The non-transitory computer-readable medium of claim 16, wherein the trading interface is used to execute trades in the trading market.

18. The non-transitory computer-readable medium of claim 16 where the acts further comprise adjusting a trading strategy used to execute trades in the trading market according to the trading prices.

19. The non-transitory computer-readable medium of claim 18 where the acts further comprise executing the trading strategy using the second trading increment.

20. The non-transitory computer-readable medium of claim 16 where the acts further comprise broadcasting the second trading increment from an exchange to a trading device.

21. The non-transitory computer-readable medium of claim 16 where the acts further comprise processing orders at an exchange using the second trading increment.
